(19) United States
(12) Patent Application Publication
(10) Pub. No.: US 2015/0310374 A1
(43) Pub. Date: Oct. 29, 2015

(54) Communication Activity Reporting

(71) Applicant: TSPHERE AUSTRALIA PTY LIMITED, New South Wales (AU)

(72) Inventors: Steve David ALLAM, Berkshire (GB); Manish Kumar GOEL, London (UK)

(21) Appl. No.: 14/649,899

(22) PCT Filed: Dec. 4, 2013
(86) PCT No.: PCT/IB2013/060611

§ 371 Date: Jun. 4, 2015

Related U.S. Application Data
(60) Provisional application No. 61/733,291, filed on Dec. 4, 2012.

(51) Int. Cl. G06Q 10/06

(52) U.S. Cl. CPC G06Q 10/06398

(57) ABSTRACT

A method and system are disclosed for automatically monitoring electronic communications and producing reports relating to staff activity levels. A predetermined set of customer contacts and electronic addresses associated with said contacts is used to relate the metadata of communications to the identified customer contacts. A report compiling a set of data relating the communications to the identified contacts or organisations, identifying the level of communications activity associated with each of said contacts or organisations, can then be produced.

### TECHNICAL FIELD

The present invention relates to monitoring, analysing and reporting activity by customer facing staff in an organisation.

### BACKGROUND OF THE INVENTION

Management of various activities of operatives with an organisation is a key part of effective management and strategy execution. Examples of existing software systems which aim to achieve this include sales management software, and customer relationship management systems, or CRMs. However, similar situations arise across a broad spectrum of activities, well beyond sales. They particularly arise in any situation where staff are required to interact with customers, clients, prospective customers and similar groups, which will be referred to hereafter as customer facing staff.

To take a simple example, a salesperson may be required to pursue a certain list of prospective customers, and manage a list of existing customers. He may be required to enter details of his contacts into a CRM system. In principle, this should produce a detailed record of contacts and interactions with each of the identified contacts.

However, in practice, this is reliant upon the salesperson accurately manually recording details of contacts on the CRM. It is common that this does not occur. Consequently, the manager of the salesperson is, in effect, reliant upon the accuracy and reliability of the salesperson in recording contacts in order to manage them effectively, coupled with their explanations and verbal reports. It will be clear that this approach is less than optimal, and does not allow a complete understanding of the activities of the customer facing staff.

It is an object of the present invention to facilitate improved reporting on the activities of sales and other customer facing staff.

### SUMMARY OF THE INVENTION

In a broad form, the present invention uses an integration of customer information (for example produced by a CRM), authenticated communications activity and metadata about those communications, this data being analysed in order to produce alerts, reports and the like on the activity of selected persons of groups.

Instead of being reliant only upon accurate entry of contact details into a CRM, the present invention uses communications metadata to match contacts with activity levels determined independently, from the actual communications activity, so as to provide additional information for management of the relevant individuals or groups.

In one aspect, the present invention provides a method for producing reports in relation to staff activity levels, including at least the steps of:

establishing a list of customer contacts or organisations of interest for one or more staff members;

Automatically compiling a log of communications to and from the one or more staff members, the log including authenticated communications with the identified customer contacts or organisations, and including both incoming and outgoing communications;

Automatically determining the customer contacts or organisations to which the communications relate, and compiling a set of data relating the communications to the identified contacts or organisations;

Processing the set of data to identify the level of communications activity associated with each of said contacts or organisations.

According to another aspect, the present invention provides a system for monitoring electronic communications and producing reports relating to staff activity levels, the system including means for monitoring said communications, means for authenticating communications, and a predetermined set of customer contacts and electronic addresses associated with said contacts, the system compiling a log of communications to and from one or more staff members, the log including authenticated communications with the identified customer contacts or organisations, and including both incoming and outgoing communications; communications;

said system automatically determining the customer contacts or organisations to which the communications relate, and compiling a set of data relating the communications to the identified contacts or organisations, and processing the set of data to identify the level of communications activity associated with each of said contacts or organisations.

### BRIEF DESCRIPTION OF THE DRAWINGS

Illustrative implementations of the present invention will now be described with reference to the accompanying figures, in which:

FIG. 1 is a schematic diagram of a system for generating message logs;

FIG. 2 is a schematic diagram of a system for generating message logs, including software components;

FIG. 3 is a flowchart showing compilation of a datastore of information identifying senders of electronic messages;

FIG. 4 is a flowchart showing the use of the datastore of information to reduce the false identification of emails;

FIG. 5 is a flowchart showing how the sender of an inbound message is checked against the sub-datastores of the white list;

FIG. 6 is a schematic diagram of the integrity engine;

FIG. 7 is a report indicating status for various notional clients;

FIG. 8 is a report for a specific client, indicating the level of email activity with various identified email addresses in a particular client; and

FIG. 9 is a report detailing email traffic to and from a particular email address.

### DETAILED DESCRIPTION OF THE INVENTION

Implementations of the present invention will now be described with reference to specific implementations, in order to facilitate a better understanding of the invention. It will be appreciated that the implementations are intended to be illustrative of the present invention, and are not limitative of the scope thereof.

While the present invention will be primarily discussed in the context of a sales management situation, it will be understood that this is meant in the broadest sense. Any customer facing staff, for example including lawyers, accountants or consultants in a professional services firm, sales and promotional staff, or any other customer facing staff, may be the subject of similar reporting and analysis in the context of the present invention. In the latter case, the reporting will typically be principally concerned with contact and activity levels with allocated clients, in some implementations cross referenced for size and importance, so to identify anomalies and matters requiring action by managers and supervisors.

The present invention may be implemented as an adjunct to a full, stand alone CRM (or similar) system which incorporates the communications analysis aspects which will be further described below. A preferred implementation uses reports or data from an existing CRM system as an input, together with the message logs and mapping information from the communications analysis, in order to provide the required analysis and reports. In a preferred form, the message logs and mapping information are provided by a communications analysis system, for example an anti-spam system which collects such data, possibly enhanced as required with additional communications logging and analysis software.

In another implementation, the present invention may operate independently of a CRM system. The tables and details such as customers, customer domains, and so forth may be manually configured at set up of the system, or as required for monitoring and reporting.

The present invention may be used with any suitable CRM system, for example Salesforce.com, SugarCRM, SAP CRM, Oracle CRM, Microsoft CRM and Amdocs ClarifyCRM. In a simple implementation, the requirement for the present invention may be a list of clients and contact details, broken down by the responsible sales staff.

A second requirement for this implementation of the present invention is a table mapping domain names to particular clients. For example, the domains cheapbooks.com, cheapbooks.co.uk, bookfair.com and ozbooks.com.au may all relate to a single account. This step is part of the initial set up of the implementation, and would typically be manually determined and input. However, in suitable implementations the list could be determined in an automated way.

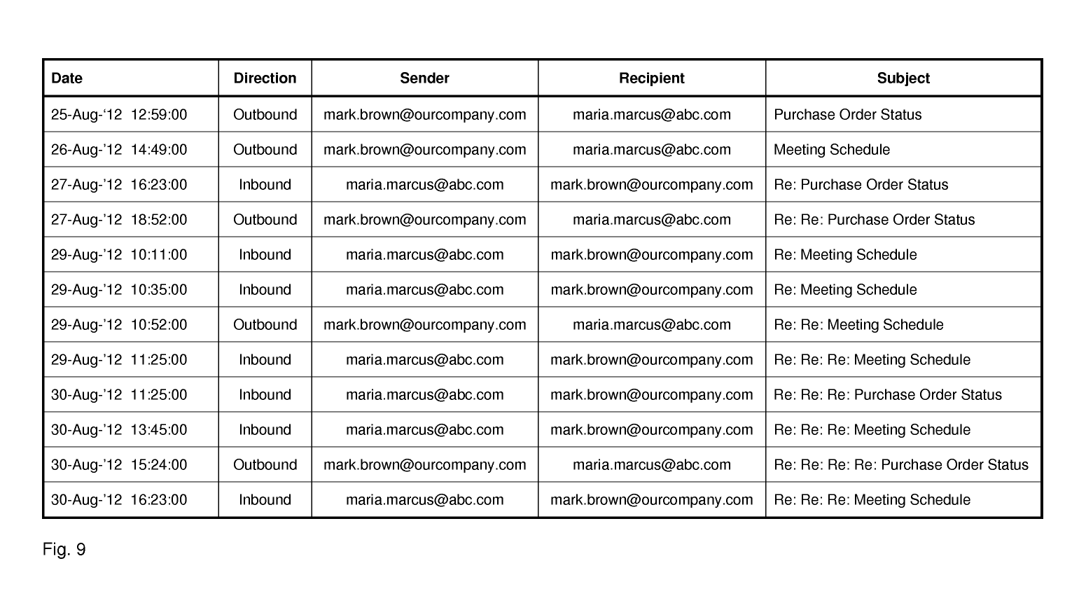

A third requirement is for message logs. The message log used would typically relate to (or be broken down by) a particular individual, in this example a sales person. The log will typically include includes both incoming and outgoing traffic, the sender and recipient details, and the subject. An example of such a log is shown in FIG. 9.

The message log is preferably more than just a listing of traffic. The log should represent a log of traffic which has been authenticated, so that the data is robust and properly reflective of activity. For example, a sales operative may seek to spoof a customer in order to appear as though they are actively persuing them. Email may appear to originate from a target domain, however, authentication may reveal that it comes from the sale operative's web mail account.

The present invention may be suitably implemented in conjunction with a system disclosed in co-pending applications WO 2010/066011, and WO2011/153582, the disclosures of which are hereby incorporated by reference.

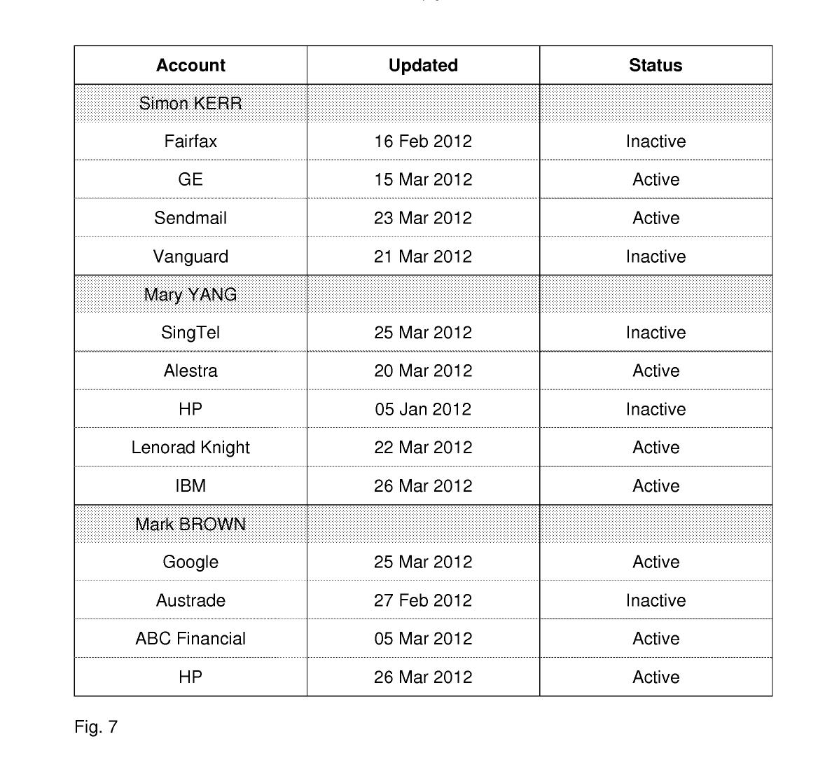

FIG. 7 illustrates an example of a report for a particular notional customer, ABC financial. A series of contact email addresses are listed, together with email traffic in and out for that address. Based on the data, an indication is provided as to whether the contact at that address is active or inactive.

This determination is made based upon criteria built into the analysis tool. For example, in one implementation, active may mean that there has been both inbound and outbound traffic to a party in a 7 day period before the report. It will be apparent that the exact rules for determining active or inactive may be varied depending upon the role, industry and the like.

In other implementations, the baseline behaviour for specific customers could be determined in different ways, for example from an analysis of the historical behaviour of a client, and the report could highlight changes from that baseline. For example, a much lower level of activity could suggest that the customer is moving to another supplier. A high level of incoming emails not matched by outgoing emails may indicate poor customer service or a serious issue with a particular customer or sales person.

An important aspect of this process is that the table of messages has been processed so as to isolate authentic, genuine messages from customers. This is determined either through standard authentication mechanisms (SPF, DKIM) or through alternative heuristics for recognising legitimate email from domains which (a) don't publish authentication information or (b) do so, but omit part of their legitimate outbound email. SPF and DKIM are existing authentication mechanisms which will be familiar to those skilled in the art, see for example http://en.wikipedia.org/wiki/Sender_Policy_Framework and http://en.wikipedia.org/wiki/DomainKeys_identified_Mail. The present invention is not limited in its implementation to any particular method for authentication. Any suitable current or later developed approach could be used. The key feature relevant to this implementation of the present invention is that the table of messages has been authenticated, not the precise mechanism by which this is achieved.

It will be appreciated that while the preceding discussion has focussed on email, the present invention could be applied to any form of electronic communications, including SMS/text, social media messages, VOIP or other voice communications, communications such as Skype, or any other form of communications for which records and suitable metadata can be automatically accessed. Different forms of communication could be differently weighted, if appropriate, in determining the activity score.

We will now provide an explanation of an example system which is capable of generating an appropriate message log for use in implementations of the present invention.

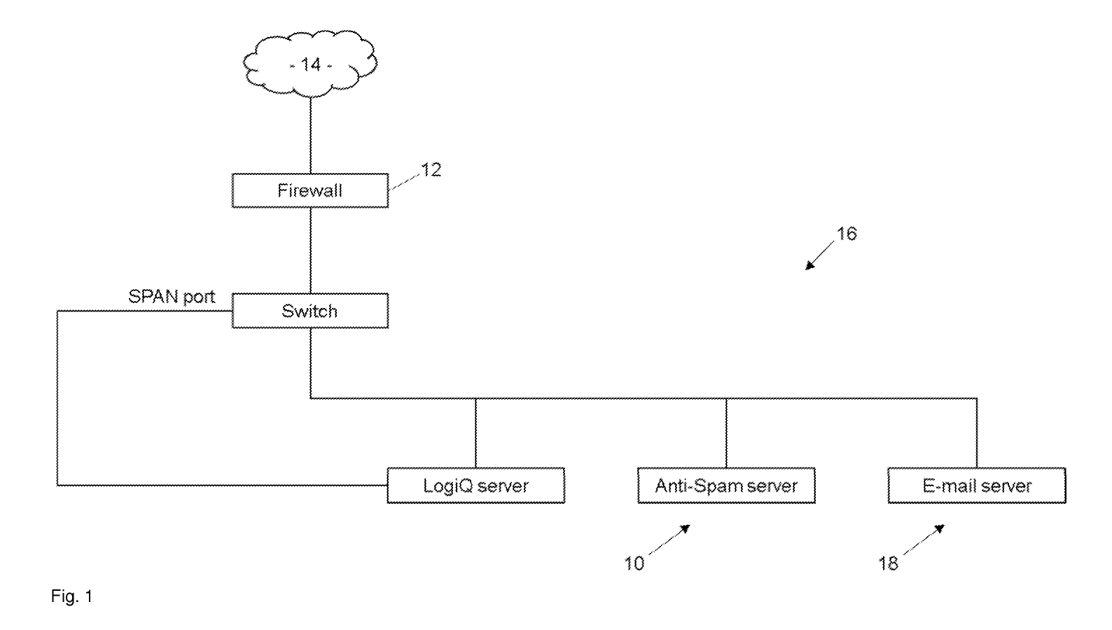

Referring first to FIG. 1, a typical installation of this example involves installing an anti-spam system 10 behind a firewall 12 which protects it from the internet 14. The anti spam system 10 interfaces with a private network 16 via an email server 18. The email server 18 operates as the email server for multiple local domains on the network.

Whilst it is contemplated that the present invention could be implemented without an accompanying anti-spam system, the present invention may be conveniently implemented as an additional function supported by such a system. It may be implemented as an additional system using appropriate communications traffic, without changing an existing anti-spam system.

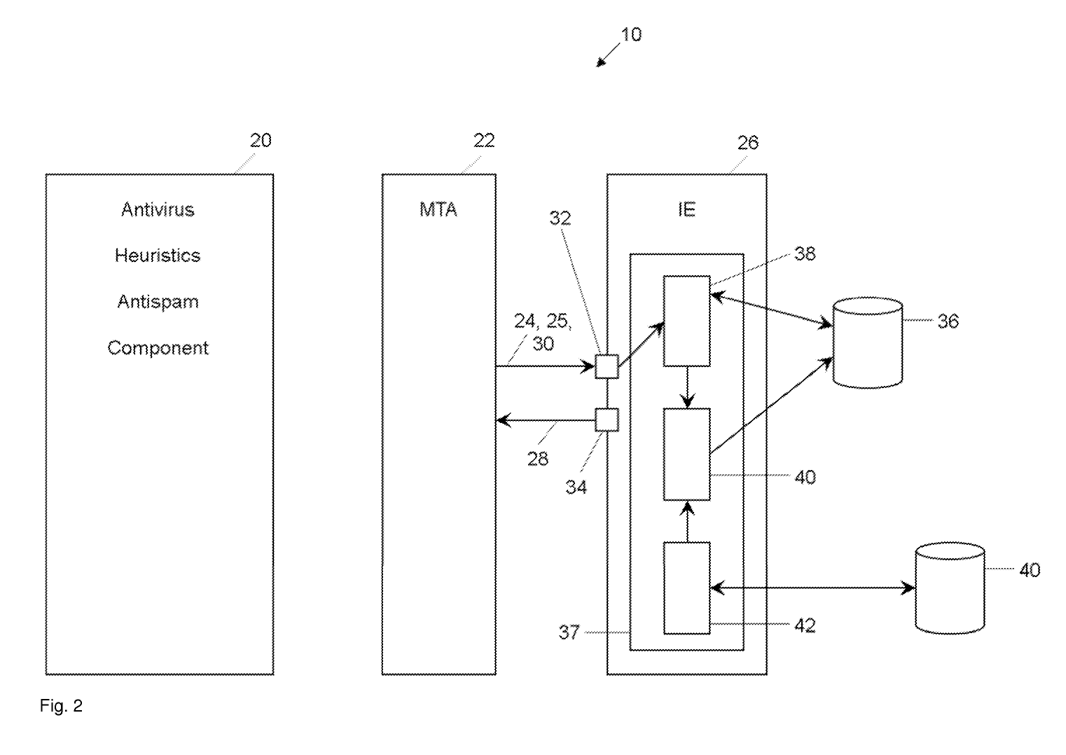

A schematic representation of the anti-spam system 10 is shown in FIG. 2. In this example the integrity engine (IE) 26 is installed as a software module in the anti-spam system 10 residing on the same server 10. Alternatively, it may reside on a separate server located on the same network, or on the Internet.

The anti-spam system 10 has anti-virus, heuristic and anti-spam components 20 that communicate with the message transport agent (MTA) 22. The MTA 22 queries the IE 26 each time an inbound email is received 30 or an outbound email 24 is sent, where the query describes that email (described in further detail below).

The IE 26 includes an additional layer of protection for the anti-spam system 10 by helping to reduce incorrect identification of wanted messages (i.e. false positives) by correctly identifying senders of wanted inbound emails. The IE 26 provides the ability to integrate an intelligent whitelisting system into an anti-spam system 10.

The queries are received at an input port 32 of the IE 26. Queries include sufficient information so that the IE 26 can make a decision 28 on whether the email is from a previously determined valid source using its processor 37 comprised of a query component 38, storage component 40, and checking component 42. The IE 26 then communicates that determination in a notification 28 to the MTA 22 from an output port 34. The MTA 22 then makes use of this notification 28 in any way it wishes, for example standard practice can be modified to suit the needs of that private network that may have very low or high security level requirements.

The IE 26 has datastorage means 36 which is a datastore, such as a database, usually referred to as a whitelist and in this example the datastore is local to the IE 26. The IE 26 automatically compiles a sender identification datastore, for example local whitelist having more than a single entry list form, such as also including hashes, tables and other information for the private network 16 based on queries 24 that it receives.

Once a query 24 or 30 is received the IE 26 first determines whether the query relates to an inbound or an outbound message. The content of the query may depend on whether it is an outbound email or an inbound email. A full query contains the following information:

I—sender/originator IP address

II—sender/originator email address

III—recipient email address.

### Compiling a Sender Identification Datastore

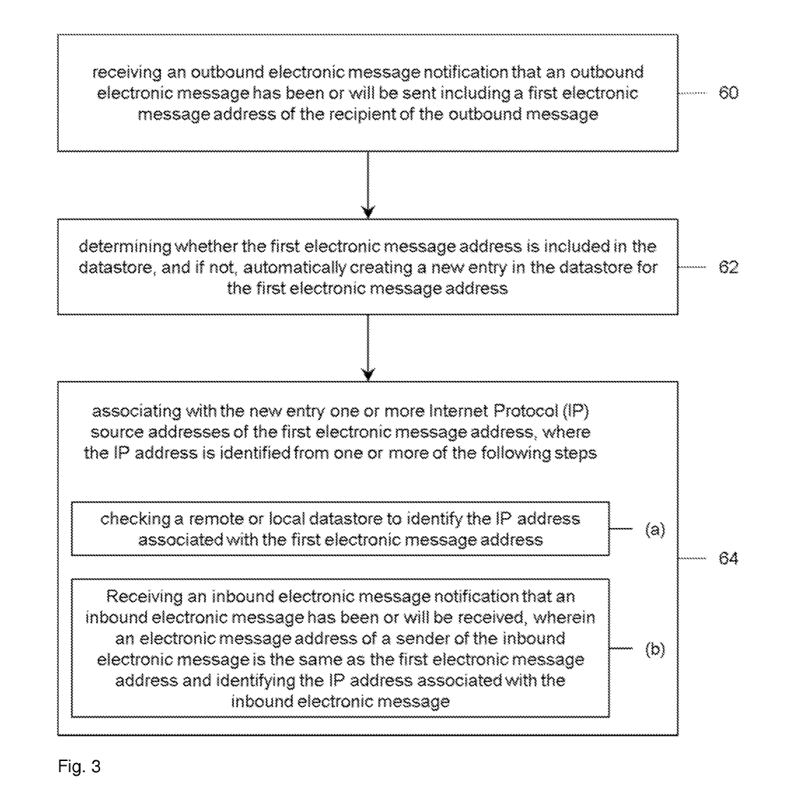

Using queries 24 to automatically compile a sender identification datastore will now be described with reference to FIG. 3. Once a message is accepted for outbound delivery by the email server 18 a query 24 is received 60 by the IE 26. For an outbound message the query 24 (i.e. notification) will include:

I—the IP address of the sender (i.e. local user) of the outbound message;

II—the email address (i.e. second electronic message address) of the sender of the outbound message;

III—the email address (i.e. first electronic message address) of the intended external recipient (i.e. remote correspondent).

A configuration file of the IE 26 includes the local domains that the email server 18 is responsible for together with IP addresses for those local mailservers handling those domains. A message is considered an outbound message if after checking the query it is determined that the senders email address is from one of the local domains and matching IP addresses of the sending mailserver as specified in the configuration file.

Alternatively, a query 24 may specify that the message is outbound meaning that the above check is not required and the query 24 would not need to include the IP address of the sender.

Every outbound email has a recipient's address (i.e. first electronic message address) that should be included in the sender identification datastore. Next, query component 38 determines 62 whether the second email address is already in the sender identification datastore 36.

In this example the datastore 36 is separated into different sub-datastores. A valid sender can be identified as sender of wanted emails:

global sub-datastore: globally by inclusion in a remote sender identification datastore stored remotely network sub-datastore;

to the entire network in a network sender identification datastore stored locally domain sub-datastore;

to one or more domains of the network in a domain sender identification datastore stored locally user sub-datastores; or

to a particular user on the private network each have their own user-sender identification datastore stored locally.

In this example, the recipient of an outbound message is automatically added by the storage component 40 to the sender's (i.e. local user sending the outbound message) sender identification datastore 36. That is, after checking, if the IE 26 determines the recipient of the outbound message is not included in the datastore 36 it is added as a new entry. Initially the entry includes the address of the recipient of the external outbound email plus a NULL entry for the IP address of this remote recipient. This record is associated with the sender of the outbound email, such as by adding a further field to the entry of the email address of the sender of the outbound email.

Alternatively, the recipient of an outbound email is identified in the sender identification datastore 36 but associated with another user. In that case, a new entry will still be added to the local senders sender identification datastore 36. A person skilled in the art would readily identify that this can also be done in a database by associating the entry for the recipient with a further user. This part record is then completed from one of the two following ways.

### Checking a Remote or Local Datastore for the IP Address 64a

The part record can be enhanced with domain specific information and IP addresses should the domain of the recipient have a remote SPF record or other external means 40 available to the IE 26 to determine the IP address of the recipient of the outgoing email.

In this example the checking component 42 sends a query containing the email address of the recipient of the outbound email to an external database 40 that will provide the corresponding IP address if available.

In this example, if this check is unsuccessful, the query component 38 then checks the datastore 36 to identify whether an IP address for the recipient of the outbound email is already captured in the sender identification datastore associated with another user. In that case, that IP address is also used to complete the record.

IP Address Taken from an Inbound Email 64b

When an inbound email is received by the email server 18, a query 25 is passed to the IE 26 after the anti-spam components 20 have determined that the inbound email is not spam. This query 25 includes at least:

I—IP address of the sender of the inbound email

II—email address of the sender of the inbound email

III—email address of the recipient of the inbound email

The sender identification datastore of the local user 36, who is the recipient of the inbound email, is queried by the query component 38 to identify whether the sender of the inbound email is in their list and the entry for the sender of the inbound email is incomplete. If so, the email is assumed to be a response to the local user's outbound email. The IP address of the sender of the email is then added to the part record by the storage component 40.

The IE 26 also tracks, amongst other things, the number of times that local users communicate with remote correspondents. This data is used when building the whitelists by limiting entries for remote correspondents where the local user is not in regular or frequent communication with the remote sender. This data also allows for the creation and updating of logs relating to the communications to and from particular correspondents.

The IE 26 also generates alerts that can be sent to individual local users or administrators. The alerts can contains details of remote senders that were not found on the sender identification datastore but which should be considered further for possible addition to the sender identification datastore. Alternatively, an administrator may choose to add new entries to the network or domain sender identification datastore.

Using the Sender Identification Datastore to Authenticate Emails

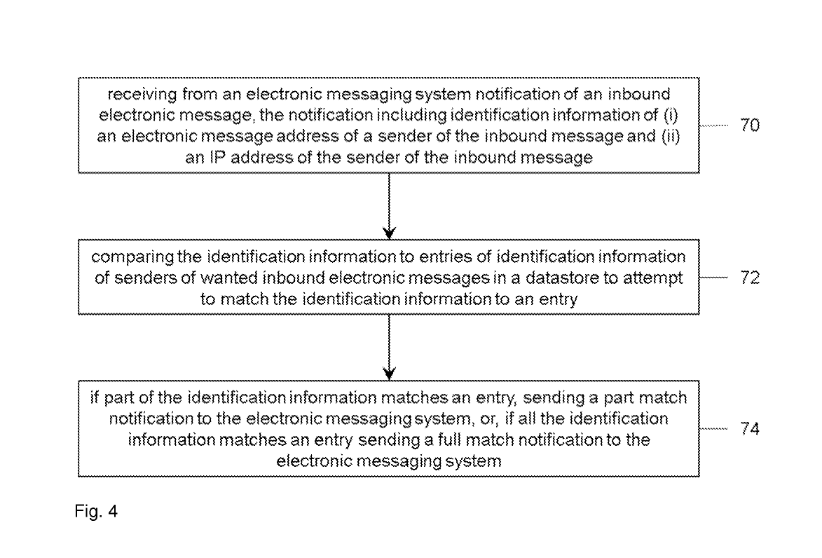

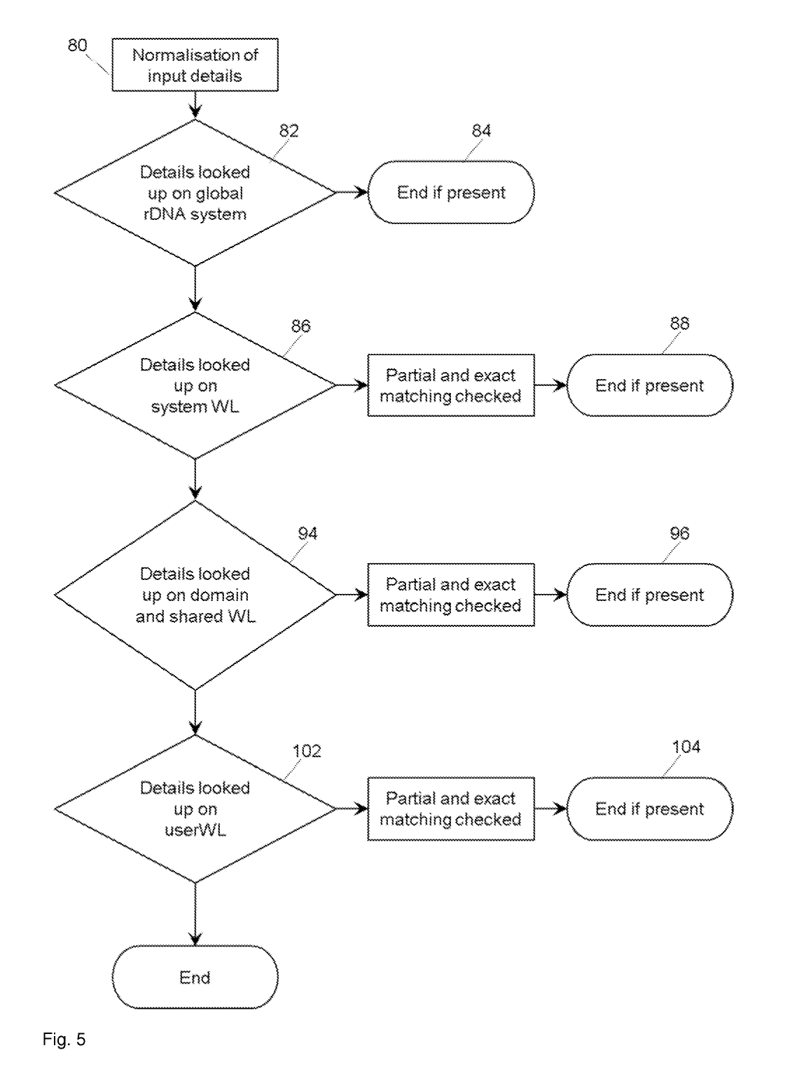

Using the sender identification datastore to identify the sender will now be described with reference to FIG. 4 and FIG. 5. When the system 10 receives an email, before checking whether the inbound email is spam, a query 30 is sent from the MTA 22 to the IE 26. In this example this query 30 is different to the query discussed in relation to 64b above which is sent after the anti-spam system determines that the email isn't spam.

The IE 26 receives 70 the query 30 (i.e. notification) containing the following identification information:

I—IP address of the sender of the inbound email

II—email address of the sender of the inbound email

III—email address of the recipient of the inbound email

Next the query component 38 compares 72 the identification information with the sender identification datastore 36. This comparison can return different levels of matching:

(i) exact match—all of the identification information was matched in the sender identification datastore

(ii) partial match (IP)—the email address of the sender has been found in the sender identification datastore and the IP address matches to the level specified in the configuration file (i.e. a certain number of octets are the same) OR

(iii) partial match (shared)—the email address has been found in the sender identification datastore but as an entry associated with a different user (i.e. in the sender identification datastore associated with another user within the same domain or domain group).

The IE 26 will return a single notification 28 to the MTA 22 from the output port 34 that includes a response code.

This comparison is shown in further detail in FIG. 5. Initially the notification is normalised whereby the parameters are checked for validity and shifted to lowercase 80. Next the identification information are looked up 82 on an external data source system which is a global whitelist. This step 82 requires the IE 26 to hash the sender's email address and IP address to ensure, for security reasons, that the raw information is not sent to the external data source. In this example the lookup is a DNS lookup, using MD5 hashed values. If the identification information is included in the external data source an appropriate further notification is received by the IE 26 from the external data source. This further notification is then converted into the notification 28 including the appropriate response code for this match that is sent to the MTA 22 and the comparing of step 72 ends 84.

Next a look up is performed 86 on the system whitelist which in this example is stored locally on the IE 26. The system whitelist is checked for a match for the senders email address or domain. If a part match or full match is found, the comparing of step 72 ends 88.

Next a look up is performed on the domain whitelist 94, user whitelist 102 in that sequence. At each stage if a full or part match is made the comparing step 72 ends 96, 104 and 108 respectively.

The domain 94 and user 102 whitelists are checked. In IE 26 there is a separation of these lists 94 and 102. In this example an extra field is provided in each entry to tag each entry as belonging to a particular domain or a particular user which is completed when an entry is added to the datastore.

Also, IE 26 must not only check the user's domain list, but check the users domain group list. If the domain is part of a domain group, then the group of domains can effectively share whitelist data. Thus, anything on the whitelist for a user ‘steve@acme.com’ is effectively on the whitelist for a user ‘steve@acme.co.uk’, assuming that acme.com and acme.co.uk are part of the same domain group.

Note that Bounce Address Tag Validation (BATV) addresses need to be normalised, before checking.

If an exact match can be found in the datastore, then the notification 28 sent to the MTA 22 including this full match code 74. Also, it is possible to have an SPF value passed into the IE 26 as a parameter, to avoid IE 26 carrying out the check itself.

If a full match is not found for the IP address, but there is a match for the email address of the sender of the inbound email, then a notification 28 that a partial match 74 is made is sent to the MTA 22. For partial matches, the IP address should be checked for the number of octets that match records in the datastore. This is used in conjunction with the configuration options in the configuration file, which allows the installer to set this level. Thus, if the configuration is set to 2 leading octet match, the IP address 10.10.23.45 will match 10.10.21.46

If an entry cannot be found in the recipient's users list, then the email address and IP address will be checked on other users list, without reference to the recipient.

If a match may be found on both originator and IP address on the local users list (but not the recipient users list) then a partial match code is returned that indicates that the partial match is based on a shared match result.

What that MTA 22 does with the code included in the notification 28 is also configurable and up to the requirements of that private network. For example, in some systems a shared match may be sufficient to deliver the inbound email to the recipient. In other systems this may not be sufficient and the email is not delivered.

### Configuration File

As mentioned above, the IE 26 configuration file contains static information that can be configured at installation time. However, this information should also be changeable via the Admin API (discussed below). Information held in the configuration file should include (but not be limited to) the following information:

License details

Domain groups

List of internal domains

List of sending mail servers for each domain

Reporting options

Partial match settings

In this example, using the configuration file the user can configure all IE 26 functions so that the IE 26 can be used without resort to the Admin API (i.e. an installation should require a correct configuration file and the IE environment (discussed below) to operate and no further actions.

The configuration file should allow for a single IE 26 instance to process queries 24 and 30 from a number of ‘sites’. Each site will have a different set of domains and users. The configuration file will be in XML format.

The following items should be included in the IE 26 configuration file that is read at start-up. There can be a single default section of the configuration file, or multiple sections (named using the site code). Configuration items are as follows:

General license-code=<our license code>encryption key, used to de-crypt incoming requests cache size to specify cache size used by IE 26 (if appropriate)

Logging

request log location, supporting both windows and Unix path names)

general log location

request log style, syslog or CSV (d=syslog)

request log entries, a list of API commands. If present, only these actions will be logged.

Whitelist Checking

partial-match-level=<num of octets to consider a match>list-precedence=global, system_white, domain_white, user_white

Daemon Options

Listen port Bind

IP address

In this example the IE configuration file is dynamic, in that the IE daemon will re-read the configuration after a change, rather than requiring a restart. The API will also include some commands that result in modifications to the configuration file.

### IE Admin API

The admin API is an integral part of the IE HTTP API. It enables the administrator to:

Configure the necessary start-up parameters for IE. For each domain group:
List of local e-mail domains
List of local IP addresses that e-mail can originate from
Settings for use of shared whitelist and shared black list
Settings for partial IP address matching (no. of octets) for whitelist

Manipulate the Whitelists and Blacklists
Add or remove entries
List or dump entries

Enable Production of Reports
For licensing purposes
Resource purposes; data size on disk, memory usage
performance purposes; number of queries handled, query throughput, breakdown of result codes

External applications and MTAs may integrate with IE by using the HTTP interface. It will require the requestor to submit the following information:

originators IP address

originators email address

recipients email address

message direction (inbound or outbound)

(optional) requestors message id

(optional) message subject (optional)

The interface will respond 28 with:

The IE response code, such as one of USERJWL5 DOMAIN_WL, SYSTEM_WL, GLOBAL_WL, IP_WL, UNKNOWN, ERROR

The IE sub-code of EXACT (an exact match was found on whitelist or black list), PARTIALJP (a partial match was found for IP), or PARTIAL_SHARED (a match was found for another domain user)

The IE reason text, a detailed message explaining why and what the orig/ip matched

The TCP interface may also be extended to allow full Administrative access, such as changing configuration, adding and removing whitelist entries etc.

Admin/User Consoles

The administrator API encapsulates all the commands necessary to configure and operate IE. It is expected that partners will use the API to integrate IE functions (such as add to whitelist) into their own user and admin interfaces. This could be in form of a graphical user interface (GUI).

Reporting Module

Reporting will be carried out by using the API functions to determine details on the IE.

The reports may be in HTML.

Logging

IE will log to two log files (a) Request log: All queries made to the API will be logged here, detailing the API call made, the parameters used and the response given Error log: A general log file for all other logging information. The configuration files specifies where these are saved.

In this example the request log is limited to only log certain queries (simply by listing them in the configuration file) and to have the request log output in either syslog or CSV format.

The IE is capable of handling a large number of incoming queries, and has the ability to be split across a number of physical servers.

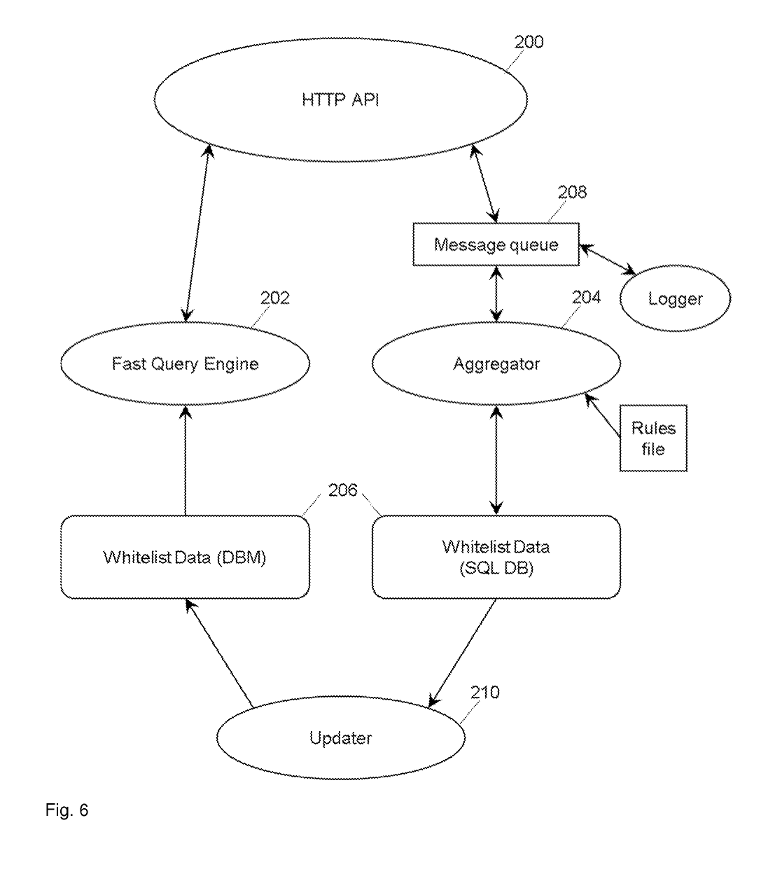

FIG. 6 shows the basic building blocks of a single node IE server. In larger deployments, the IE can be split across multiple servers down the middle of the diagram, with the HTTP API, FQE, DBM data on one server, and the other components on another server, or more than one server.

HTTP API 200 The HTTP API component is responsible for:

Accepting whitelist lookup requests from clients 30

Accepting whitelist data that is used to build the whitelists 24, 25

Accepting and responding to ‘admin’ requests.

Alternatively, the HTTP API 200 could be split across a number of nodes, so that requestors can make admin requests on one node, and other requests another node.

The HTTP API component 200 controls the other sub components, and returns the responses 28 to the requestor. It runs as a daemon.

An admin API request consists of an HTTP POST, using a URL that contains the request command, with the POST body containing an XML stream containing any parameters required for the request. Responses are returned as XML in the body of the returned page. Other (query) requests use standard HTTP GET methods.

The HTTP API may operate using either the HTTP or the HTTPS protocols depending on configuration.

The API controls the calling and responses from the Fast Query Engine (FQE) 202 and Slow Query Engine (SQE) 204. It is possible that both the FQE and SQE return multiple values. The API must return a single value to the requestor.

Data Storage 206

The data for IE is stored in two places:

A dbm style database for the FQE 202

An extended dbm style database for the SQE 204 The dbm database is a simple key/value pair that contains whitelist and blacklist data. The input files for the creation of the dbm databases consist of keys and values as detailed in the following table:

| File | Key | Value |
|---|---|---|
| Ip.dat | IP | Source domains9s) |
| system.dat | Sender/domain | Complex structure detailing |
| | | known recips, IP addresses |
| Domaingroup.dat | Sender/domain | Complex structure detailing |
| | | known recips, IP addresses |

Thus, each domain group has its own dbm file. Entries for originator and recipient may contain the * character—not as a wildcard, but to denote wildcard type usage:

Full value: steve@acme.com Domain only: *@acme.com

The domain only value arises when a user/admin wishes to accept messages from all users at a domain—this value is entered into the whitelist directly. In order to use this data, it becomes necessary to ▪ carry out two searches, steve@acme.com and *@acme.com. If either search finds a matching record, then the IE identifies a match.

Due to the nature of the application, its possible that there may be many (even hundreds) of domains being handled, and thus hundreds of dbm files. The FQE 202 must be able to cache the dbm files to ensure that the most frequently used files are held open.

The extended dbm database contains data in a similar manner to the dbm files, but is used when more complex queries are carried out, as the full power of a rdb can be used when generating search queries.

The extended dbm data consists again of one table for the system black/whitelist and one table per domain group.

Fast Query Engine (FOE) 202

The FQE is implemented as a component of the HTTP API. The FQE may also be accessed using a DNS type interface.

It is responsible for carrying out fast, exact matches on the static whitelist data, known as ‘simple’ matching. IE may be configured to carry out simple matching only in real time, or to carry out both simple and complex matching in real time.

The FQE queries a (semi) static set of whitelist data, held in a dbm format, described above.

The data in these files is basically a key/value pair. The FQE receives the data from the API and carries out up to 6 queries on the underlying data, looking for:

An exact match for the IP, orig, recip A match for a IP match

IP/orig match

IP/domain match

So, for a message sent from (1.1.1.1) steve@acme.com-̂ david@bs.com, this data will be processed in order to look up the following keys:

The result(s) of the lookups are returned to the API for processing and response to the requestor. The lookups may result in more than one result—i.e. a match may be found in the system list as well as the domain list. In which case, the precedence ordering will be decided by the HTTP API component.

The FQE is capable of processing key lookups in parallel. The FQE handles the absence of a dbm file gracefully, such as stop and wait for a period before retrying (this is to cover the time period when a dbm file is being re-written by the updater).

Aggregator 204

The Aggregator 204 is passed data for aggregation from the FQE including new (unseen) IPs, new senders and partial match data.

Message Queue 208

The Aggregator operates by monitoring a message queue. The message queue may be spread amongst a number of servers.

Updater 210 The purpose of the updater is to run periodically to extract data from the extended dbm database and update the dbm databases for the FQE. to determine which messages should be delivered and which require further analysis.

This example can be deployed on a large scale—across a whole organisation or a large user base (such as an internet service provider). This example is entirely automated and self-learning, and so while it may automatically create personal datastores at an individual user level, it also creates datastores across an organisation or entire communications network. In this way it can manage large volumes of communication requests while ensuring accurate delivery of these through mass customisation of user preferences.

### Generation of Message Logs

Message logs for use in implementations of the present invention preferably include a listing of messages (illustratively emails) to and from identified recipients. The recipients and sender email addresses should be authenticated, as discussed above.

In terms of the implementation described above, the message log is a table including at least the source IP address, From: address, To: address; Subject; and authentication results. These are derived from the processes described above.

The message log, client list and domain list are combined, so as to produce the reports.

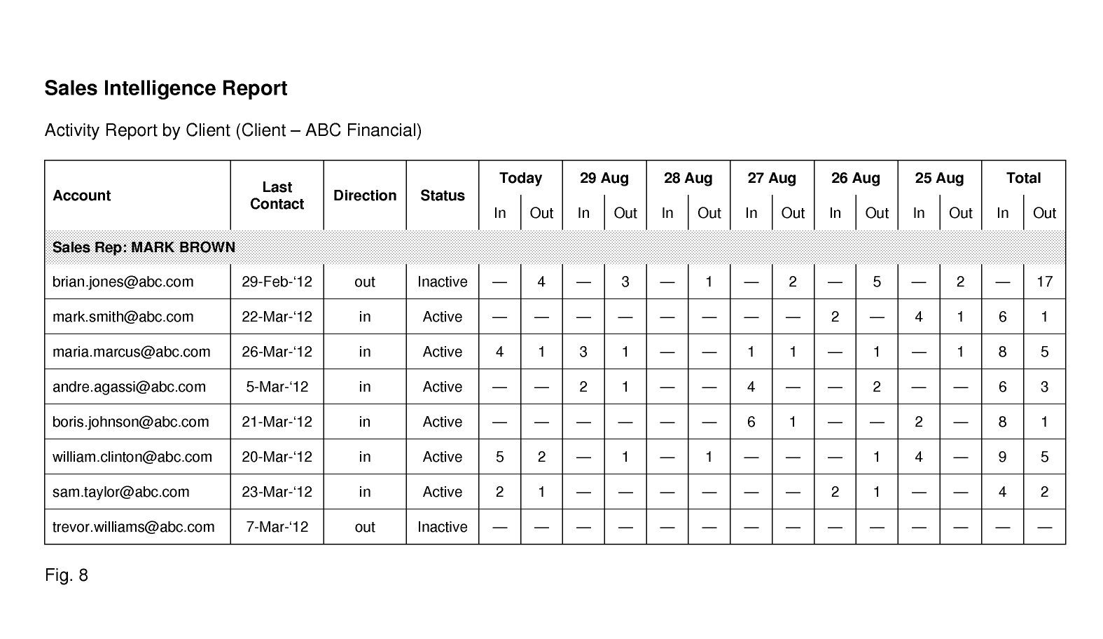

FIG. 8 illustrates a more detailed report on the sales activity associated with a notional client, ABC financial. The responsible sales representative is listed, together with a list of the email addresses associated with ABC financial. Communications in and out over specific periods, in this case days, are listed, together with an indication of whether the contact is active or inactive. Based on a predetermined set of criteria.

It will be appreciated by persons skilled in the art that numerous variations and/or modifications may be made to the subject matter shown in the specific embodiments without departing from the scope of the claims as broadly described.

Electronic messaging/communication may be defined as a system that transmits data or provides a communications channel between two parties in an electronic format such as email, SMS or VoIP. The example makes use of the terminology used for email. However, it may be applied to any electronic messaging or communications system that connects two or more parties.

In the example above the IE is installed as a separate software module in the anti-spam system 10. In another alternative installation, the IE may be tightly integrated into the anti-spam system on the same server.

The components of the processor may be a combination of both hardware and software acting on the hardware.

In alternative installations the IE may be on a separate physical machine that is then queried across the network by the anti-spam system. In this case the IE will have a Communications port to receive queries 24, 25 and 30 and send the notification 28. It will have its own processor to perform the method of compiling and using the whitelist as described above. It will have (directly or indirectly) a connection to the Internet so that global whitelist checks can be made with remote databases.

The datastore may be queried in a flexible way. The example above uses an HTTP API to query the datastore. Also used in other implementations are presentation as a DNS zone file and also presentation as a simple text file.

It should also be understood that, unless specifically stated otherwise as apparent from the following discussion, it is appreciated that throughout the description, discussions utilizing terms such as “receiving”, “processing”, “retrieving”, “selecting”, “calculating”, “determining”, “displaying” or the like, refer to the action and processes of a computer system, or similar electronic computing device, that processes and transforms data represented as physical (electronic) quantities within the computer system's registers and memories into other data similarly represented as physical quantities within the computer system memories or registers or other such information storage, transmission or display devices. Unless the context clearly requires otherwise, words using singular or plural number also include the plural or singular number respectively.

1. An automated method for producing reports in relation to staff activity levels, including at least the steps of:
establishing a list of customer contacts or organisations of interest for one or more staff members;
automatically compiling a log of communications to and from each of the one or more staff members, the log including authenticated communications with the identified customer contacts or organisations, and including both incoming and outgoing communications;
automatically determining the customer contacts or organisations to which the communications relate, and compiling a set of data relating the communications to the identified contacts or organisations;
processing the set of data to identify the level of communications activity associated with each of said contacts or organisations; and
generating a report including, for each of said one or more staff members, identifying the level of communications activity associated with each of said customer contacts and/or organisations of interest.

2. A method according to claim 1, wherein the level of communications activity is determined using predetermined criteria relating to one or more of: the number of incoming messages associated with said contact or organisation; the number of outgoing messages associated with said contact or organisation and the time period over which said communications have occurred.

3. A method according to claim 1, wherein a report, further identifies at least a level of communications activity for one or more specific customers or organisations, and provides an indication of whether predefined levels of activity for those specific contacts or organisations have or have not been achieved.

4. A method according to claim 1, wherein the log of communications is compiled with reference to a table mapping a set of domains to each identified contact or organisation.

5. A system for monitoring electronic communications and producing reports relating to staff activity levels, the system including means for monitoring said communications, means for authenticating communications, and a predetermined set of customer contacts and electronic addresses associated with said contacts, the system compiling a log of communications to and from one or more staff members, the log including authenticated communications with the identified customer contacts or organisations, and including both incoming and outgoing communications; communications;
said system automatically determining the customer contacts or organisations to which the communications relate, and compiling a set of data relating the communications to the identified contacts or organisations, and processing the set of data to identify the level of communications activity associated with each of said contacts or organisations.

6. A system according to claim 5, wherein the level of communications activity is determined using predetermined criteria which include relating to one or more of number of incoming messages associated with said contact or organisation, number of outgoing messages associates with said contact or organisation, and the time period over which said communications have occurred.

7. A system according to claim 5, wherein the set of data is used to generate a report, which identifies at least a level of communications activity for one or more specific customers, and provides an indication that predetermined levels of activity have or have not been achieved.

8. A system according to claim 5, wherein the log of communications is compiled with reference to a table mapping a set of domains to each identified contact or organisation.

9. A method according to claim 2, wherein report, further identifies at least a level of communications activity for one or more specific customers or organisations, and provides an indication of whether predefined levels of activity for those specific contacts or organisations have or have not been achieved.

10. A method according to claim 2, wherein the log of communications is compiled with reference to a table mapping a set of domains to each identified contact or organisation.

11. A method according to claim 3, wherein the log of communications is compiled with reference to a table mapping a set of domains to each identified contact or organisation.

12. A system according to claim 4, wherein the set of data is used to generate a report, which identifies at least a level of communications activity for one or more specific customers, and provides an indication that predetermined levels of activity have or have not been achieved.

13. A system according to claim 6, wherein the log of communications is compiled with reference to a table mapping a set of domains to each identified contact or organisation.

14. A system according to claim 7, wherein the log of communications is compiled with reference to a table mapping a set of domains to each identified contact or organisation.
